(19) United States
(12) Patent Application Publication
(10) Pub. No.: US 2025/0089104 A1
(43) Pub. Date: Mar. 13, 2025

(54) SYSTEMS AND METHODS FOR PROVIDING A FIXED MOBILE CONVERGENCE SERVICE

(71) Applicant: JIO PLATFORMS LIMITED, Ahmedabad (IN)

(72) Inventors: Birendra Singh BISHT, Navi Mumbai (IN); Harbinder Pal Singh SAINI, Navi Mumbai (IN); Anurag SINHA, Dombivli East, Mumbai (IN); Sandeep GUPTA, Dwarka (IN); Rohit SOREN, Dumka (IN)

(21) Appl. No.: 18/029,679

(22) PCT Filed: Mar. 11, 2023
(86) PCT No.: PCT/IB2023/052349

§ 371 Date: Mar. 31, 2023

(30) Foreign Application Priority Data
Mar. 30, 2022 (IN) 202221018944

(51) Int. Cl. H04W 76/10; H04L 65/1016; H04L 65/1063; H04W 76/30

(52) U.S. Cl. CPC H04W 76/10; H04L 65/1016; H04L 65/1063; H04W 76/30

(57) ABSTRACT

The present disclosure generally relates to wireless communication systems, more particularly to systems and methods for providing Fixed Mobile Convergence (FMC) service. System receives contact number/short code of first user dialed by second user, and establishes connection between BTAS and IMS server, when second user dials mobile number. Further, system invokes FMC create/update service to trigger modification of IFC service chaining data in IMS core network. Furthermore, system converts short code and transmits invite request messages to IMS core network and triggers ringing mode on mobile/fixed line device. In response to conversion, system transmit invite request messages to IMS core network of mobile number link to fixed line, and in response to transmission, system triggers ringing mode on mobile device and fixed line device, to establish call. Additionally, system establishes call between mobile device and fixed line device of second user, and fixed line/mobile device of first user, respectively.

### FIELD OF INVENTION

The embodiments of the present disclosure generally relate to wireless communication systems. More particularly, the present disclosure relates to systems and methods for providing a Fixed Mobile Convergence (FMC) service using a Business Telephony Application Server (BTAS) associated with a Central exchange (Centrex) group.

### BACKGROUND OF THE INVENTION

The following description of the related art is intended to provide background information pertaining to the field of the disclosure. This section may include certain aspects of the art that may be related to various features of the present disclosure. However, it should be appreciated that this section be used only to enhance the understanding of the reader with respect to the present disclosure, and not as admissions of prior art.

In general, one or more enterprise users may be assigned with a fixed line desk phone in the office premise and the mobile numbers of the respective user may be associated with the fixed line desk phone allocated to a first user. When a second user calls the first user using the short code (i.e., extension) or a full number of the desk phone (from outside of a Central exchange (Centrex) group), the call may be forked (parallel or sequential) to both the desk phone and the associated mobile number/phone of the first user. During the established call, the user can also do the seamless call pickup from the associated mobile/fixed phone.

Further, simultaneous ringing may be a Private Branch Exchange (PBX) feature that may route incoming calls to multiple phones at the same time. Calls can be forwarded to a user's desk phone, computer, and mobile device, as well as to multiple users.

However, the conventional systems may not provide a short code dialing from mobile in addition to fixed line phone of an enterprise user. The conventional systems may not provide a single extension/number/short for the user to receive incoming calls on both devices (i.e., mobile as well as fixed line phone), outside a closed user group/PBX.

Considering the requirement for a short code dialing from a mobile device in addition to the fixed line phone of an enterprise user (Centrex group), there may be a need in the art to provide systems and methods that can overcome the shortcomings of the existing prior art, by providing systems and methods for providing a Fixed Mobile Convergence (FMC) service using a Business Telephony Application Server (BTAS) associated with a Central exchange (Centrex) group.

### OBJECTS OF THE PRESENT DISCLOSURE

Some of the objects of the present disclosure, which at least one embodiment herein satisfy are as listed herein below.

In a general aspect, the present disclosure provides systems and methods for providing a Fixed Mobile Convergence (FMC) service using a Business Telephony Application Server (BTAS) associated with a Central exchange (Centrex) group.

In another aspect, the present disclosure provides systems and methods to convert a short code to a relevant fixed line number and ring both mobile and fixed line.

In another aspect, the present disclosure determines, if the call is answered on a fixed line or mobile device, and then disconnects the call on a mobile/fixed line, when the call is answered on fixed line/mobile, respectively.

In another aspect, the present disclosure allows short code dialing from mobile in addition to fixed line phone of an enterprise user, in the cloud Internet Protocol (IP) Central exchange (Centrex).

In another aspect, the present disclosure provides a single extension/number for a user to receive incoming calls on both devices (i.e., mobile as well as a fixed-line phone).

In another aspect, the present disclosure enables user experience including dialing from a mobile phone, dialing from the fixed phone, calling from outside Enterprise user to fixed phone, and seamless call pickup from associated fixed or mobile.

In another aspect, the present disclosure allows seamless call pickup, where the call is answered up from a mobile number (e.g., C-party) associated with the respective fixed line (e.g., B-party).

### SUMMARY

This section is provided to introduce certain objects and aspects of the present invention in a simplified form that are further described below in the detailed description. This summary is not intended to identify the key features or the scope of the claimed subject matter.

In an aspect, the present disclosure provides a system for providing a Fixed Mobile Convergence (FMC) service. The system receives at least one of a contact number and a short code associated with a first user of a Central exchange (Centrex) group, dialed by a second user using at least one of a mobile device or a fixed line device. The contact number and the short code corresponds to at least one of a mobile number and a fixed line number associated with the first user of the Centrex group. Further, the system establishes a connection between the BTAS and an Internet protocol Multimedia Subsystem (IMS) core network associated with an IMS server, when the second user dials the mobile number and the fixed line is linked to the mobile number. Further, the system invokes, upon establishing the connection between the BTAS and the IMS core network, at least one of a Fixed Mobile Convergence (FMC) create service and a FMC update service, to trigger a modification of an Initial Filter criteria (IFC) service chaining data in the IMS core network. Furthermore, the system converts the short code to a relevant at least one of the fixed line number and the mobile number, when the second user dials the short code. Thereafter, in response to the conversion, the system transmits one or more invite request messages to the IMS core network associated with the mobile number link to the fixed line. Further, in response to the transmission, the system triggers a ringing mode on the mobile device and the fixed line device, to establish a call. Additionally, the system establishes the call between at least one of the mobile device or the fixed line device associated with the second user, and at least one of the fixed line device and the mobile device associated with the first user, respectively.

In another aspect, the present disclosure provides a method for providing a Fixed Mobile Convergence (FMC) service. The method includes receiving at least one of a contact number and a short code associated with a first user of a Central exchange (Centrex) group, dialed by a second user using at least one of a mobile device or a fixed line device. The contact number and the short code corresponds to at least one of a mobile number and a fixed line number associated with the first user of the Centrex group. Further, the method includes establishing a connection between the BTAS and an Internet protocol Multimedia Subsystem (IMS) core network associated with an IMS server, when the second user dials the mobile number and the fixed line is linked to the mobile number. Furthermore, the method includes invoking upon establishing the connection between the BTAS and the IMS core network, at least one of a Fixed Mobile Convergence (FMC) create service and a FMC update service, to trigger a modification of an Initial Filter criteria (IFC) service chaining data in the IMS core network. Additionally, the method includes converting the short code to a relevant at least one of the fixed line number and the mobile number, when the second user dials the short code. Further, the method includes, in response to the conversion, transmitting one or more invite request messages to the IMS core network associated with the mobile number link to the fixed line. Furthermore, the method includes, in response to the transmission, triggering a ringing mode on the mobile device and the fixed line device, to establish a call. Additionally, the method includes establishing, by the processor, the call between at least one of the mobile device or the fixed line device associated with the second user, and at least one of the fixed line device or the mobile device associated with the first user, respectively.

In another aspect, the present disclosure relates to a user equipment for providing a FMC. The user equipment may include a processor and a memory coupled to the processor, where the memory comprises processor-executable instructions, which on execution, cause the processor to transmit at least one of a contact number and a short code associated with a first user of a Central exchange (Centrex) group, dialed by a second user using at least one of the user equipment, where the contact number and the short code correspond to at least one of a mobile number and a fixed line number associated with the first user, and establish a call between the user equipment associated with the second user and the first user.

In another aspect, the present disclosure relates to a non-transitory computer-readable medium including machine-readable instructions that are executable by a processor to receive at least one of a contact number and a short code associated with a first user of a Central exchange (Centrex) group, dialed by a second user using at least one of a mobile device or a fixed line device, where the contact number and the short code corresponds to at least one of a mobile number and a fixed line number associated with the first user of the Centrex group, establish a connection between a Business Telephony Application Server (BTAS) and an Internet protocol Multimedia Subsystem (IMS) core network associated with an IMS server, when the second user dials the mobile number and the fixed line is linked to the mobile number, invoke, upon establishing the connection between the BTAS and the IMS core network, at least one of a Fixed Mobile Convergence (FMC) create service and a FMC update service, to trigger a modification of an Initial Filter criteria (IFC) service chaining data in the IMS core network, convert the short code to a relevant at least one of the fixed line number and the mobile number, when the second user dials the short code, in response to the conversion, transmit one or more invite request messages to the IMS core network associated with the mobile number link to the fixed line, in response to the transmission, trigger a ringing mode on the mobile device and the fixed line device, to establish a call, and establish the call between at least one of the mobile device or the fixed line device associated with the second user, and at least one of the fixed line device or the mobile device associated with the first user, respectively.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that the invention of such drawings includes the invention of electrical components, electronic components, or circuitry commonly used to implement such components.

FIGS. 1A and 1B illustrate exemplary network architectures in which or with which system of the present disclosure can be implemented, in accordance with an embodiment of the present disclosure.

FIG. 2A with reference to FIG. 1A, illustrates an exemplary representation of a network device, in accordance with an embodiment of the present disclosure.

FIG. 2B illustrates an exemplary representation of flow diagrams showing integration architecture of network device or BTAS, in accordance with embodiments of the present disclosure.

FIGS. 3A-3C illustrate exemplary sequence diagram representations of parallel call forking flows, in accordance with an embodiment of the present disclosure.

FIG. 4 illustrates an exemplary sequence diagram representation of a call flow for seamless call pickup, in accordance with an embodiment of the present disclosure.

FIG. 5 illustrates an exemplary sequence diagram representation of a call flow (activation/deactivation) of a FMC service, in accordance with an embodiment of the present disclosure.

FIG. 6 illustrates an exemplary flow chart for a method of providing a Fixed Mobile Convergence (FMC) service, in accordance with an embodiment of the present disclosure.

FIG. 7 illustrates an exemplary computer system in which or with which embodiments of the present invention can be utilized, in accordance with embodiments of the present disclosure.

The foregoing shall be more apparent from the following more detailed description of the invention.

### DETAILED DESCRIPTION OF INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Various embodiments of the present disclosure provide systems and methods for providing a Fixed Mobile Convergence (FMC) service. The present disclosure may convert a short code to a relevant fixed line number and ring both mobile and fixed line. The present disclosure may determine, if the call is answered on a fixed line or mobile device, and then disconnect the call on a mobile/fixed line, when the call is answered on fixed line/mobile, respectively. The FMC service may allow short code dialing from mobile in addition to fixed line phone of an enterprise user, in the cloud Internet Protocol (IP) Central exchange (Centrex). The present disclosure provides a single extension/number for a user to receive incoming calls on both devices (i.e., mobile as well as a fixed-line phone). The user experience may include, dialing from a mobile phone, dialing from the fixed phone, calling from outside Enterprise user to a fixed phone, and seamless call pickup fan from associated fixed or mobile. The present disclosure allows seamless call pickup, where the call is answered up from a mobile number (C-party) associated with the respective fixed line (B-party).

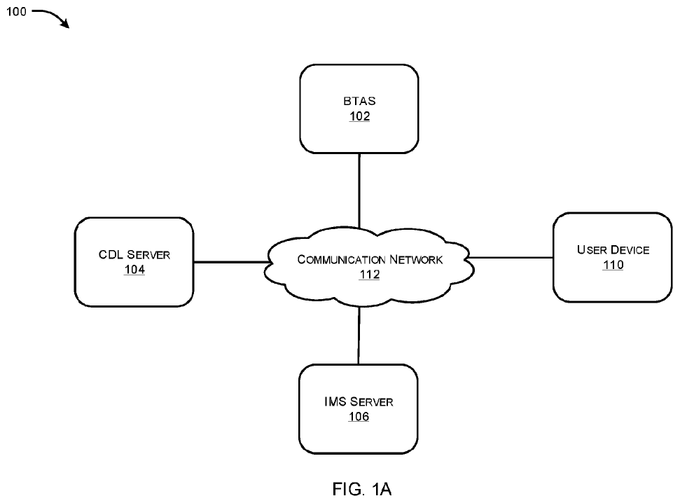

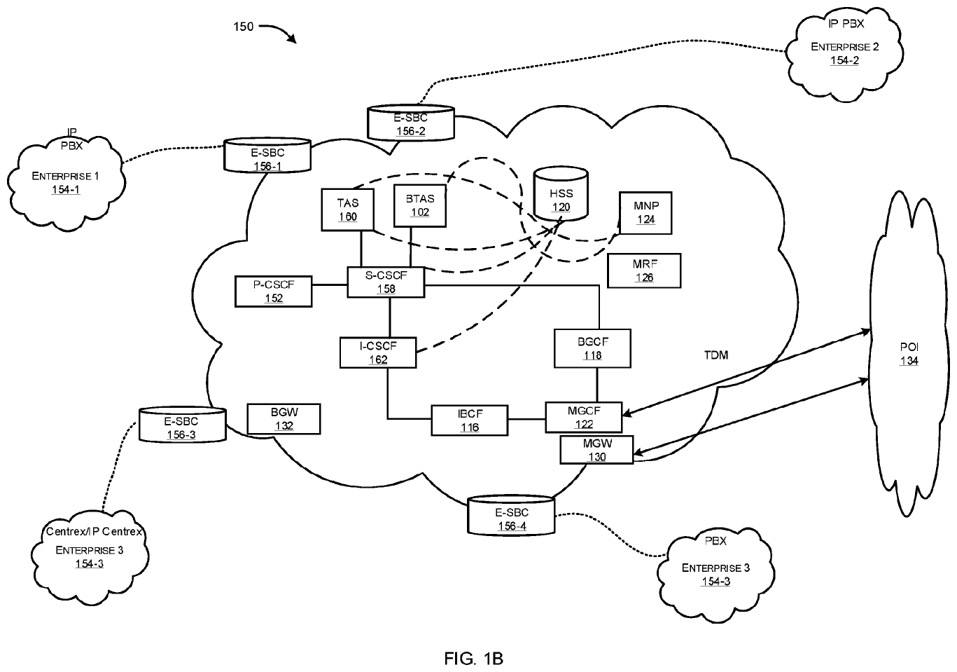

FIGS. 1A and 1B illustrate exemplary network architectures (100) and (150), respectively, in which or with which system (100) of the present disclosure can be implemented, in accordance with an embodiment of the present disclosure. As illustrated in network architecture (100) (or the system 100) of FIG. 1A, a network device (102) (network device hereinafter interchangeably referred to as a Business Telephony Application Server (102) or a BTAS (102)) may be configured to facilitate providing a Fixed Mobile Convergence (FMC) service to a user device (110). The network device (or the BTAS) (102) may be configured as an application server and may be communicably operational or may be integrated with the Internet protocol Multimedia Subsystem (IMS) server (106) (interchangeably referred to as the IMS server (106) or an IMS core network (106)). The IMS server (106) may pertain to a vendor or network/service provider to provide the Fixed Mobile Convergence (FMC) service to the user device (110). In an embodiment, the BTAS (102) or the network device (102) may be implemented in an existing IMS implementation to facilitate network service corresponding to a communication network (112). For an example, the communication network (112) may pertain to, but is not limited to, a Third Generation (3G) network service, a Fourth Generation (4G) network service, a Fifth Generation (5G) network service, a Sixth Generation (6G) network service, a New Radio (service), an Open

Radio Access Network (O-RAN) service, an Internet of Things (IoT) network service, and the like. In an embodiment, the BTAS (102)/network device (102) may be communicatively coupled to a Centralized Data Layer (CDL) server (104) or a CDL framework (104) that may enable to access information stored across different physical hosts across multiple or different circles/clusters for enabling other aspects or features pertaining to the Fixed Mobile Convergence (FMC) services.

The user device (110) (also interchangeably referred to as a user equipment (110) or UE (110) or terminal (110)) may be at least one of a wired device or wireless device. For example, the wired device may be a landline phone, a terminal device, or any other stationary device through which communication may be established. The wireless device may be a mobile device that may include, for example, a tablet, a phablet, and a cellular telephone, such as a feature phone or smartphone, and other devices. The user device (110) may include, but not be limited to, the above-mentioned devices, but may include any type of device capable of wired or wireless communication, such as a cellular phone, a tablet computer, a personal digital assistant (PDA), a personal computer (PC), a laptop computer, a wearable computer, a media center, a work station, and other such devices. In an embodiment, the user device (110) may be at least one of the wireless or wireline devices that may be subscribed or registered to the network service provided by the network/service provider. In an example embodiment, the network/service may pertain to, but is not limited to, the 3G/4G/5G/6G/NR/O-RAN/IoT network. Further, the network/service provider may provide the network service corresponding to at least one of a cellular network service, a private network service, a satellite network service, or a convergence network service, and the like.

In an embodiment, the communication network (112) pertaining to a BTAS-based IMS implementation may be the 3G/4G/5G/6G/NR/O-RAN/IoT network that may include at least one of a wireless network, a wired network, or a combination thereof. The communication network (112) may be implemented as one of the different types of networks, such as Intranet, Local Area Network (LAN), Wide Area Network (WAN), Internet, and the like. Further, the communication network (112) can either be a dedicated network or a shared network. The shared network can represent an association of the different types of networks that can use a variety of protocols, for example, a Hypertext Transfer Protocol (HTTP), a Transmission Control Protocol/Internet Protocol (TCP/IP), a Wireless Application Protocol (WAP), an Automatic repeat request (ARQ), and the like. In an embodiment, the communication network (112) may pertain to the 3G/4G/5G/6G/NR/O-RAN/IoT network that may be facilitated through, for example, a Global System for Mobile communication (GSM) network; a Universal Terrestrial Radio Network (UTRAN), an Enhanced Data rates for GSM Evolution (EDGE) Radio Access Network (GERAN), an Evolved Universal Terrestrial Radio Access Network (E-UTRAN), a Wireless Fidelity (Wi-Fi) or other LAN access network, or a satellite or terrestrial wide-area access network such as a Wireless Microwave Access (WiMAX) network, and the like. In an example embodiment, the communication network (112) may enable 3G/4G/5G/6G/NR/O-RAN/IoT network based on a subscription pertaining to the user/user device (110) and/or through a Subscriber Identity Module (SIM) card. Various other types of communication network (110) or network/service may be possible.

In an example, the communication network (112) may utilize a different sort of an air interface, such as a Code Division Multiple Access (CDMA), a Time Division Multiple Access (TDMA), or a Frequency Division Multiple Access (FDMA) air interface, and another implementation. In an example embodiment, the wireline/fixed-line user device may use wired access networks, exclusively or in combination with wireless access networks, for example, including Plain Old Telephone Service (POTS), Public Switched Telephone Network (PSTN), Asynchronous Transfer Mode (ATM), and other network technologies configured to transport Internet Protocol (IP) packets, and the like.

In an embodiment, the system 100 may execute the BTAS (102) to receive at least one of a contact number and a short code associated with a first user of a Central exchange (Centrex) group, dialed by a second user using at least one of a mobile device or a fixed line device (i.e., user device 110). The contact number and the short code may correspond to at least one of a mobile number and a fixed line number associated with the first user of the Centrex group.

In an embodiment, the system (100) may execute the BTAS (102) to establish a connection between the BTAS (102) and an Internet protocol Multimedia Subsystem (IMS) core network (106) associated with the IMS server (106), when the second user dials the mobile number and the fixed line is linked to the mobile number.

In an embodiment, the system (100) may execute the BTAS (102) to invoke, upon establishing the connection between the BTAS (102) and the IMS core network (106), at least one of a Fixed Mobile Convergence (FMC) create service and a FMC update service, to trigger a modification of an Initial Filter criteria (IFC) service chaining data in the IMS core network (106).

In an embodiment, the system (100) may execute the BTAS (102) to convert the short code to a relevant at least one of the fixed line number and the mobile number, when the second user dials the short code.

In an embodiment, the system (100) may execute the BTAS (102) to transmit, in response to conversion, one or more invite request messages to the IMS core network (106) associated with the mobile number linked to the fixed line.

In an embodiment, the system (100) may execute the BTAS (102) to trigger, in response to transmission, a ringing mode on the mobile device (110) and the fixed line device (110), to establish a call. In an embodiment, triggering the ringing mode on the mobile device (110) and the fixed line device (110) further includes at least one of a ringing simultaneously on the fixed line device (110) and the mobile device (110), and ringing sequentially first on the fixed line device (110) and then on the mobile device (110), based on a provisioned parallel forking mode or a sequential forking mode. In an embodiment, when the ringing mode is triggered on at least one of the fixed line device (110) and the mobile device (110), the first user answers the call alternatively on an alternate contact number, by dialing a service code from the alternate contact number.

In an embodiment, the system (100) may execute the BTAS (102) to determine periodically if, the call is answered on the fixed line device (110) or the mobile device (110).

In an embodiment, the system (100) may execute the BTAS (102) to disconnect the call in the mobile device (110) or the fixed line device (110), when the call is answered in the fixed line device (110) or the mobile device (110), respectively.

In an embodiment, the system (100) may execute the BTAS (102) to establish the call between at least one of the mobile device (110) or the fixed line device (110) associated with the second user, and at least one of the fixed line device (110) or the mobile device (110) associated with the first user, upon disconnecting the call in the mobile device (110) or the fixed line device (110).

In an embodiment, the fixed line device (110) associated with the first user displays a Calling Line Identification (CLI), and the mobile device (110) associated with the first user displays the mobile number of the second user. In an embodiment, the fixed line device (110) associated with the second user displays a Calling Line Identification (CLI) and the mobile device (110) associated with the second user displays the short code of the first user.

In an embodiment, wherein the FMC service is activated upon inputting a pin via Dual-Tone Multi-Frequency Tones (DTMF), and the FMC service is deactivated upon inputting a pin via the DTMF, and wherein the FMC service is not deleted during deactivation.

In an embodiment, when the short code corresponds to the fixed line number, the system (100) may execute the BTAS (102) to convert the dialed short code to the fixed line number using a Virtual Private Branch Exchange (VPBX) service. Further, the system (100) may execute the BTAS (102) to trigger an Online Charging System (OCS) (not shown in FIG. 1A), for charging the second user, using a Credit Control Request (CCR). The OCS transmits back a Credit Control Answer (CCA) corresponding to the CCR. Additionally, the system (100) may execute the BTAS (102) to interact with a Serving Call Session Control Function (SCSCF) associated with the IMS core network (106). The SCSCF may apply the Initial Filter Criteria (IFC) based on at least one of the mobile number and the fixed line number of the first user. Further, the system (100) may execute the BTAS (102) to determine an appropriate Fixed Mobile Convergence (FMC) service to be invoked for FMC data associated with the at least one of the mobile number and the fixed line number of the first user. Furthermore, the system (100) may execute the BTAS (102) to provide at least one of an announcement and a ringtone to the second user. Additionally, the system (100) may execute the BTAS (102) to route invite to the fixed line number associated with the first user, and invite request messages to the IMS core network (106) associated with the mobile number. Further, the system (100) may execute the BTAS (102) to trigger a ringing mode on the mobile device (110) and the fixed line device (110), to establish the call. Furthermore, the system (100) may execute the BTAS (102) to trigger the OCS for update charging as the at least one of the fixed line number and the mobile number, based on answering of the call by the first user in the fixed line device (110) or the mobile device (110), respectively. Additionally, the system (100) may execute the BTAS (102) to disconnect the call in the mobile device (110) or the fixed line device (110), when the call is answered in the fixed line device (110) or the mobile device (110), respectively. Further, the system (100) may execute the BTAS (102) to establish the call between the fixed line device (110) associated with the second user, and at least one of the fixed line device (110) or the mobile device (110) associated with the first user, upon disconnecting the call in the mobile device (110) or the fixed line device (110).

In an embodiment, answering the call further comprises an event of answering the call from the mobile number associated with a third user when the call is established in the fixed-line number associated with the second user. The system (100) may execute the BTAS (102) to establish the call between the first user and the third user, upon inserting call details and routing details by the third user to the Centralized Data Layer (CDL) server (104). Further, the system (100) may execute the BTAS (102) to fetch, by the BTAS associated with the second user, the call details and routing details from the CDL server (104).Furthermore, the system (100) may execute the BTAS (102) to establish the call between the first user and the second user. In reference to FIG. 1B, the network service (corresponding to (112) in FIG. 1A) may be provided to multiple entities or enterprises, such as, for example, enterprise-1 (154-1), enterprise-2 (154-2), enterprise-3 (154-3), and enterprise-4 (154-4) (collectively termed as the enterprises (154) and individually as the enterprise (154)). In an embodiment, at least one of the enterprises (154) may include an Internet Protocol Private Branch Exchange (IP-PBX) (not shown in FIG. 1B) to enable switching calls between user devices (110) on local lines. Each enterprise 154 may communicate with the communication network/servers through an Enterprise Session Border Controllers (E-SBC) (156-1, 156-2, 156-3, and 156-4). As shown in FIG. 1B, each enterprise 154, for example, enterprise-1 (154-1), enterprise-2 (154-2), enterprise-3 (154-3), or the enterprise-4 (154-4) may be facilitated with the network service (such as 3G/4G/5G/6G/NR/O-RAN/IoT network service) through the E-SBC (156-1, 156-2, 156-3 and 156-4), respectively. The E-SBC (156) may be an executable set of instructions for enabling connectivity and security pertaining to the network of the enterprises and service providers. The IP-PBX may be a private branch exchange or a telephone switching system within an enterprise, which may enable, for example, switching calls between users within an enterprise. In an embodiment, the BTAS (102) may be communicatively coupled with other components, such as, for example, IP telephone and provisioning servers. In an example embodiment, the IP-PBX may communicate with the E-SBC (156) via a Session Initiation Protocol (SIP) technique. The enterprise may pertain to an entity including, but not limited to, an organization, a company, a business, an educational campus, an office campus, a shopping center, a residential area/community, and various other entities that may wish to avail the communication network by the service provider. In an embodiment, the communication network may be available only within a pre-defined zone (allowed zone) of the enterprise. Various other types of entities/provisions are possible.

The IMS server (106 of FIG. 1A) may include one or more modules or components that may enable it to perform one or more functions. For example, the IMS server (106) may be an existing IMS core including components/modules handling various functions such as, a Serving-Call Session Control Function (S-CSCF) module (158), Interrogating-Call Session Control Function (I-CSCF) module (162), Proxy-Call Session Control Function (P-CSCF) module (152). In an embodiment, the BTAS (102) may be integrated with a network of the IMS core (106) and other application servers to provide a network service pertaining to, for example, the 4G/5G/6G network. For example, the other application server may include a Telephony Application Server (TAS) (160), which may be considered a general component used in a communication network to provide telephony applications and additional multimedia functions. In another example, the other application server may include Mobile Number Portability (MNP) server (124), which may provide number portability to users such as, for example, may allow retaining the same number upon a change in the service provider. Various other servers may be integrated into the BTAS-enabled IMS implementation for enabling one or more services pertaining to communication network or 3G/4G/5G/6G/NR/O-RAN/IoT network without departing from the scope of the ongoing description.

In reference to the components pertaining to the IMS server (106), the S-CSCF module (158) may be a primary node in the IMS server (106) responsible for session control. In an embodiment, a list of subscribers may be allocated to the respective S-CSCF module (158) at the time of IMS registration in order to facilitate the routing of Session Initiation Protocol (SIP) messages as part of service establishment procedures. In operation, the S-CSCF module (158) may enable downloading a subscriber profile from a Home Subscriber Server (HSS) (120) at the time of IMS registration. The I-CSCF module (162) may be a key clement in the IMS server (106) and may enable any request to be routed to an appropriate S-CSCF module (158) from multiple S-CSCFs within the network. The I-CSCF module (162) may also interrogate the HSS (120) to obtain an address of the relevant S-CSCF module (158) to process a SIP initiation request. As shown in FIG. 1B, the P-CSCF module (152) may act as an ingress and egress point to and from an IMS domain of the service provider with respect to the IMS client. The P-CSCF module (152) may perform general functions, such as, for example, onward routing of registration and session requests to the correct nodes in the communication network, updating the S-CSCF module (158), maintaining a secure connection with the user device (110), and other such functions. In an embodiment, the network device (102) or the BTAS (102) may be communicatively coupled or integrated with one or more functional components such as, for example, the Session Initiation Protocol (SIP) based application server. The SIP server may be built with features pertaining to the type of enterprise (154).

Further, as shown in FIG. 1B, to provide various aspects of the network service (e.g., pertaining to 3G/4G/5G/6G/NR/O-RAN/IoT network), the components of the IMS server (106) (such as S-CSCF, I-CSCF module) may also include components/modules that pertain to functions, for example, a Breakout Gateway Control Function (BGCF) module (118), a Media Gateway Control Function (MGCF) module (122), an Interconnect Border Control Function (IBCF) (116) and other components/modules. In a general implementation, the BGCF module (118) may enable routing call signaling to and from the most appropriate the S-CSCF module (158). In the present implementation, the BGCF module (118) may enable to route of the call to a respective BTAS (102) for providing FMC services. In general, the MGCF module (122) may be a SIP endpoint that can interface with Security Gateway (SGW) (not shown in FIG. 1B) and may also control resources in Media Gateway (MGW) (130). The IBCF module (116) may enable boundary control between various service provider networks, thus providing a BTAS-enabled IMS network security in terms of signaling information. The IMS server (106) may also include other existing components such as, for example, a component pertaining to a Multimedia Resource Function (MRF) module (126). The MRF module (126) in conjunction with other components of IMS, may be responsible for executing various processing tasks on media streams associated with particular services. Further, as shown in FIG. 1B, as the BTAS-IMS-based implementation, may be associated with Point of Interconnection (POI) (134), which may be the physical interface between media gateways of varying service providers or enterprises.

In an embodiment, the FMC service may be dependent on the core network of the service provider. In an alternate embodiment, the core network may be of the same service provider, or two or more service providers. The FMC service may work in a single service provider network as well as two or more service provider networks.

In an embodiment, a Voice over Long-Term Evolution (VoLTE) subscriber may be served by a vendor TAS (160). Further, the IMS network (106) and the BTAS (102) may only serve fixed-line enterprise subscribers. For the FMC feature to work, it is assumed that an Independent System Operator (ISO) may enable an Initial Filter Criteria (IFC) modification at a Home Subscriber Server (HSS) 120/CFX (i.e., which controls every service in an all-IP network and makes possible new subscriber services such as the VoLTE, a Voice over Wi-Fi (VoWiFi), a Rich Communication Service (RCS) and a Web Real-Time communications (WebRTC)) for the VoLTE subscriber whenever FMC create service data, FMC update service data or a FMC delete service data Application Programming Interfaces (APIs) operations are invoked by the BTAS (102). For example, whenever the BTAS (102) invokes the FMC create service data API, it is assumed that the ISO process call flow modifies the VoLTE subscriber IFC service chaining data to ensure that the BTAS (102) comes first before the TAS (160) in originating and terminating IFC leg. In another example, whenever the BTAS (102) invokes the FMC update service data, it may be assumed that the ISO process call flow modifies the VoLTE subscriber IFC service chaining data of previously configured subscriber to ensure that the BTAS (102) does not enter in originating and terminating IFC leg and only the TAS (160) comes in call routing newly configured subscriber to ensure that the BTAS (102) comes first before the TAS (160) in originating and terminating IFC leg. Further, whenever the BTAS (102) invokes the FMC create service data API, it may be assumed that the ISO process call flow modifies the VoLTE subscriber IFC service chaining data to ensure that the BTAS (102) comes first before the TAS (160) in originating and terminating IFC leg. In addition, the VoLTE subscriber service profile may remain as-is and all supplementary services may be handled by the TAS (160) only.

In one example, changes may be required from a network perspective, such as the HSS (120), and an Online Charging Server (OCS) (not shown in FIG. 1B). For, the HSS (120), whenever the association between fixed-line and the VoLTE subscribers may be established using BTAS APIs, the ISO may be required to modify the VoLTE subscriber IFC in the HSS (120) with sequencing as the BTAS (1st Priority) and the TAS/Converge TAS (CTAS) (2nd Priority)—in originating and terminating leg. Further, whenever the association between fixed-line and the VoLTE subscribers is removed using the BTAS APIs, the IFC may have to be modified for the VoLTE subscribers so that the BTAS (102) may not be involved for VoLTE subscribe calls.

For the OCS, charging for the Volte subscribers may be the responsibility of a VoLTE TAS. Further, the BTAS (102) may send a charging trigger for fixed-line only (Mobile Originated (MO), Mobile Terminated (MT), proxy mode), if activated. By default, Enterprise Centrex “Ro” trigger may be disabled.

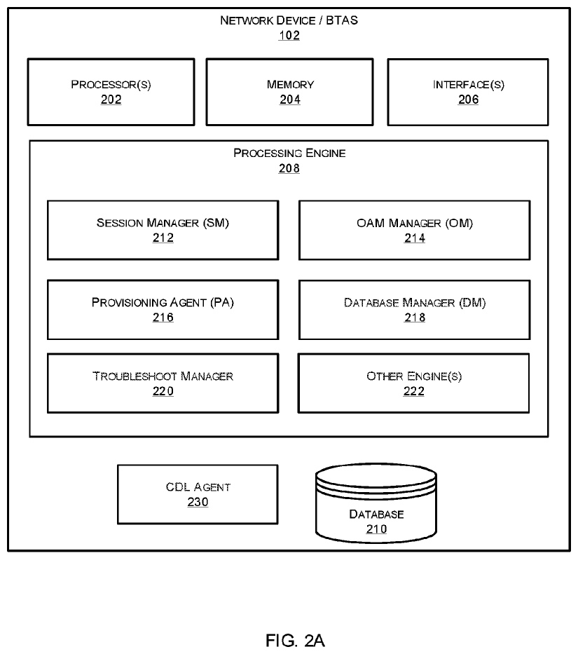

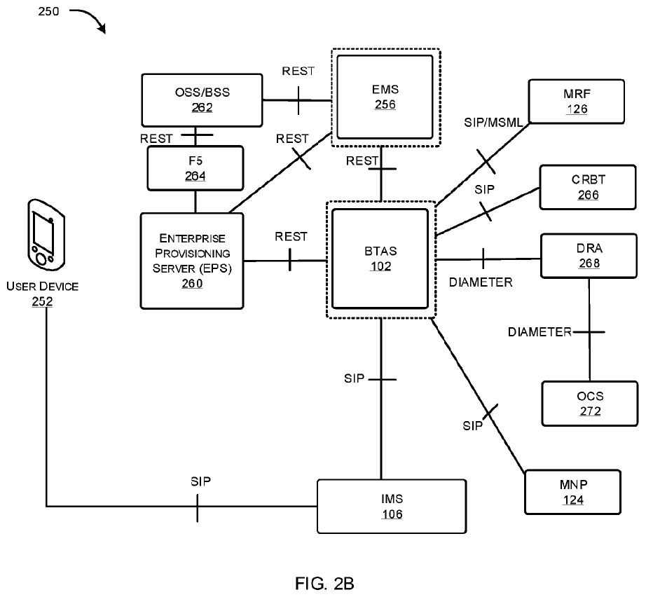

The system (100) may facilitate the Fixed Mobile Convergence (FMC) services by a combination of hardware and software implementation. FIG. 2A with reference to FIG. 1A, illustrates an exemplary representation of the network device (102)/the BTAS (102), in accordance with an embodiment of the present disclosure. The system (100) includes the network device (102) or the BTAS (102) that may include one or more processors (202). The network device (102) or the BTAS (102) may be integrated with the IMS server (106) to provide a network service to the user device (110) (as shown in FIG. 1A). In an aspect, the network device (102) may include one or more processor(s) (202) coupled with a memory (204). The memory (204) may store instructions which when executed by one or more processors (202) may cause the system (100) to perform the steps as described herein. The network device (102) or the BTAS (102) may cause the system (100) to receive, through the IMS server (106 of FIG. 1A), a routed request.

The one or more processor(s) (202) may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the BTAS (102). The memory (204) may be configured to store one or more computer-readable instructions or routines in a non-transitory computer-readable storage medium, which may be fetched and executed to create or share data packets over a network service. The memory (204) may comprise any non-transitory storage device including, for example, volatile memory such as RAM, or non-volatile memory such as EPROM, flash memory, and the like.

In an embodiment, the BTAS (102) may include an interface(s) (206). The interface(s) (206) may comprise a variety of interfaces, for example, interfaces for data input and output devices, referred to as I/O devices, storage devices, and the like. The interface(s) (206) may facilitate communication of the BTAS (102). The interface(s) (206) may also provide a communication pathway for one or more components of the BTAS (102). Examples of such components include, but are not limited to, processing engine(s) (208), a database (210), and a Centralized Data Layer (CDL) agent (230).

The processing engine(s) (208) may be implemented as a combination of hardware and programming (for example, programmable instructions) to implement one or more functionalities of the processing engine(s) (208). In the examples described herein, such combinations of hardware and programming may be implemented in several different ways. For example, the programming for the processing engine(s) (208) may be processor-executable instructions stored on a non-transitory machine-readable storage medium, and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the BTAS (102) may comprise the machine-readable storage medium storing the instructions and the processing resource to execute the instructions, or the machine-readable storage medium may be separate but accessible to the BTAS (102) and the processing resource. In other examples, the processing engine(s) (208) may be implemented by electronic circuitry.

The processing engine (208) of the network device may include one or more components (as shown in FIG. 2A) including a Session Manager (SM) (212), an Operations and Maintenance (OAM) manager (214), a provisioning agent (216), a Database Manager (DM) (218), a Troubleshooting Manager (TM) (220), and other engines (222). The SM (212) may act as a core functional delivery module that may be responsible for call processing and service chaining logic execution in the case of the BTAS (102). The SM (212) may further include one or more sub-modules such as the call initiation module (not shown) for initiating a communication with the plurality of emergency services. The OAM manager (214) may be configured for managing fault, configuration, and performance aspects of the BTAS/network device (102). The OAM manager (214) may provide operations and maintenance touch points to the system (100) or the BTAS (102). The DM (218) may manage database clusters, whereas the BTAS (102) may store subscriber-specific service information. In an embodiment, a service data modification request that may be received by the provisioning agent (216) may be stored persistently using the DM manager (218). The provisioning agent (216) may be responsible for handling provisioning requests received from the centralized provisioning server for persisting changes in the database (210). The provisioning agent (218) may also ensure that various session managers (212) may be updated about any dynamic changes in the service data. The TM (220) may aggregate logs and may debug information from all the functional managers for troubleshooting. The TM (220) may also provide flexibility to generate debug information, for example, in a module-wise, process-wise, and system-wise manner. Various other functions of the components may be possible. In an embodiment, the database (210) may comprise data that may be either stored or generated as a result of functionalities implemented by any of the components of the processing engine(s) (208) of the BTAS (102).

In an embodiment, the SM (212) may receive at least one of a contact number and a short code associated with a first user of a Central exchange (Centrex) group, dialed by a second user using at least one of a mobile device or a fixed line device (i.e., the user device (110)). The contact number and the short code may correspond to at least one of a mobile number and a fixed line number associated with the first user of the Centrex group.

In an embodiment, the SM (212) may establish a connection between the BTAS (102) and an Internet protocol Multimedia Subsystem (IMS) core network (106) associated with the IMS server (106), when the second user dials the mobile number and the fixed line is linked to the mobile number.

In an embodiment, the SM (212) may execute the BTAS (102) to invoke, upon establishing the connection between the BTAS (102) and the IMS core network (106), at least one of a Fixed Mobile Convergence (FMC) create service and a FMC update service, to trigger a modification of an Initial Filter criteria (IFC) service chaining data in the IMS core network (106).

In an embodiment, the SM (212) may convert the short code to a relevant at least one of the fixed line number and the mobile number, when the second user dials the short code.

In an embodiment, the SM (212) may transmit, in response to conversion, one or more invite request messages to the IMS core network (106) associated with the mobile number link to the fixed line.

In an embodiment, the SM (212) may trigger, in response to transmission, a ringing mode on the mobile device (110) and the fixed line device (110), to establish a call. In an embodiment, triggering the ringing mode on the mobile device (110) and the fixed line device (110) further includes at least one of a ringing simultaneously on the fixed line device (110) and the mobile device (110), and ringing sequentially first on the fixed line device (110) and then on the mobile device (110), based on a provisioned parallel forking mode or a sequential forking mode. In an embodiment, when the ringing mode is triggered on at least one of the fixed line device (110) or the mobile device (110), the first user answers the call alternatively on an alternate contact number, by dialing a service code from the alternate contact number.

In an embodiment, the SM (212) may determine periodically if, the call is answered on the fixed line device (110) or the mobile device (110).

In an embodiment, the SM (212) may disconnect the call in the mobile device (110) or the fixed line device (110), when the call is answered in the fixed line device (110) or the mobile device (110), respectively.

In an embodiment, the SM (212) may establish the call between at least one of the mobile device (110) or the fixed line device (110) associated with the second user, and at least one of the fixed line device (110) or the mobile device (110) associated with the first user, upon disconnecting the call in the mobile device (110) or the fixed line device (110).

In an embodiment, the fixed line device (110) associated with the first user displays a Calling Line Identification (CLI), and the mobile device (110) associated with the first user displays the mobile number of the second user. In an embodiment, the fixed line device (110) associated with the second user displays a Calling Line Identification (CLI) and the mobile device (110) associated with the second user displays the short code of the first user.

In an embodiment, wherein the FMC service is activated upon inputting a pin via Dual-Tone Multi-Frequency Tones (DTMF), and the FMC service is deactivated upon inputting a pin via the DTMF, and wherein the FMC service is not deleted during deactivation.

In an embodiment, when the short code corresponds to the fixed line number, the system 100 may execute the BTAS (102) to convert the dialed short code to the fixed line number using a Virtual Private Branch Exchange (VPBX) service. Further, the system (100) may execute the BTAS (102) to trigger an Online Charging System (OCS) (not shown in FIG. 1A), for charging the second user, using a Credit Control Request (CCR). The OCS transmits back a Credit Control Answer (CCA) corresponding to the CCR. Additionally, the system (100) may execute the BTAS (102) to interact with a Serving Call Session Control Function (SCSCF) associated with the IMS core network (106). The SCSCF may apply the Initial Filter Criteria (IFC) based on at least one of the mobile number and the fixed line number of the first user. Further, the system (100) may execute the BTAS (102) to determine an appropriate Fixed Mobile Convergence (FMC) service to be invoked for FMC data associated with the at least one of the mobile number and the fixed line number of the first user. Furthermore, the system (100) may execute the BTAS (102) to provide at least one of an announcement and a ringtone to the second user. Additionally, the system (100) may execute the BTAS (102) to route invite to the fixed line number associated with the first user, and invite request messages to the IMS core network (106) associated with the mobile number. Further, the system (100) may execute the BTAS (102) to trigger a ringing mode on the mobile device (110) and the fixed line device (110), to establish the call. Furthermore, the system (100) may execute the BTAS (102) to trigger the OCS for update charging as the at least one of the fixed line number and the mobile number, based on answering of the call by the first user in the fixed line device (110) or the mobile device (110), respectively. Additionally, the system (100) may execute the BTAS (102) to disconnect the call in the mobile device (110) or the fixed line device (110), when the call is answered in the fixed line device (110) or the mobile device (110), respectively. Further, the system (100) may execute the BTAS (102) to establish the call between the fixed line device (110) associated with the second user, and at least one of the fixed line device (110) or the mobile device (110) associated with the first user, upon disconnecting the call in the mobile device (110) or the fixed line device (110).

In an embodiment, answering the call further comprises an event of answering the call from the mobile number associated with a third user when the call is established in the fixed-line number associated with the second user. The system 100 may execute the BTAS (102) to establish the call between the first user and the third user, upon inserting call details and routing details by the third user to the Centralized Data Layer (CDL) server (104). Further, the system (100) may execute the BTAS (102) to fetch, by the BTAS associated with the second user, the call details and routing details from the CDL server (104). Furthermore, the system (100) may execute the BTAS (102) to establish the call between the first user and the second user.

FIG. 2B illustrates an exemplary representation of flow diagrams showing integration architecture (250) of the network device or the BTAS (102), in accordance with embodiments of the present disclosure. As shown in FIG. 2B, the BTAS (102) may be integrated or coupled with various hardware/software components or servers for enabling one or more functions pertaining to the FMC services. The BTAS (102) may be integrated with the IMS server (106) to enable the communication processing pertaining to a user device within an enterprise (154), as shown in FIG. 1B. In an example embodiment, the BTAS (102) may be integrated with the IMS server (106) to establish and control communication connections via network protocol including, but not limited to, Session Initiation Protocol (SIP), and the like. As the communication may also involve the use of media in one or more forms, the BTAS (102) may integrate with the Multimedia Resource Function (MRF) (126). The BTAS (102) may interface with an Enterprise Provisioning Server (EPS) (260) via a Representational State Transfer (REST) protocol to enable the provisioning of service data.

In an example embodiment, the BTAS (102) may integrate with the MRF (126) to enable functions, such as, for example, media mixing, control of announcement, and other such purposes via network protocol including, but not limited to, Session Initiation Protocol Media Server Markup Language (SIP-MSML). In an example embodiment, the BTAS (102) may be integrated or coupled with other components/services such as the Mobile Number Portability (MNP) (124) (via SIP) for enabling number portability dipping. In another example embodiment, the BTAS (102) and the EPS (260) may be independently integrated or coupled with an Element Management System (EMS) (256) via the REST protocol. The EMS (256) may include hardware and software implementation for managing the five key aspects i.e., Fault, Configuration, Accounting, Performance, and Security (FCAPS) functionality via representational state transfer (REST) protocol to exchange messages pertaining to the key aspects that can use hypertext transfer protocol (HTTP) to transport the messages. The EMS may provide a foundation to implement an Operations Support System (OSS) or a Business Support Systems (BSS) (262) based architecture that enables service providers to meet customer needs for example, for rapid deployment of services, to enable providing a satisfying quality of service requirements and other such services. The EMS (256) may interface with the OSS/BSS (262) via the REST protocol to enable a northbound interface for FCAPS data of the BTAS (102) or the EPS (260). The term northbound interface may relate to an interface that allows a particular component of a network to communicate with a higher-level component. The OSS/BSS (262) may interface with the EPS (260) via the REST protocol to enable functions such as, for example, service data management requests.

Further, as shown in FIG. 2B, the BTAS (102) may be integrated or coupled with a Diameter Routing Agent (DRA) (268) via diameter protocol, which may be a standard protocol for authentication, authorization, and accounting information in the IMS server-based network. The DRA diameter may be a functional element that may provide real-time routing capabilities to ensure that messages are routed among the correct elements in a network. The integration of BTAS (102) with the DRA (268) may enable integration with an Online Charging System (OCS) (272) for facilitating ‘Ro’ charging. The OCS (272) may be a system that allows a service provider to charge users or customers in real-time based on service usage, and wherein the ‘Ro’-charging pertains to a protocol that enables trigger to generate charging events. In an embodiment, the BTAS (102) may also be integrated with components pertaining to a Customized Caller Ring Back Tone (CRBT) (266) for enabling a personalized Ring Back Tone (RBT) at the stage of establishing the communication. For example, this may be mainly related to the ring-back tone that may be played while connecting a call communication of the user device (252) with the plurality of emergency services.

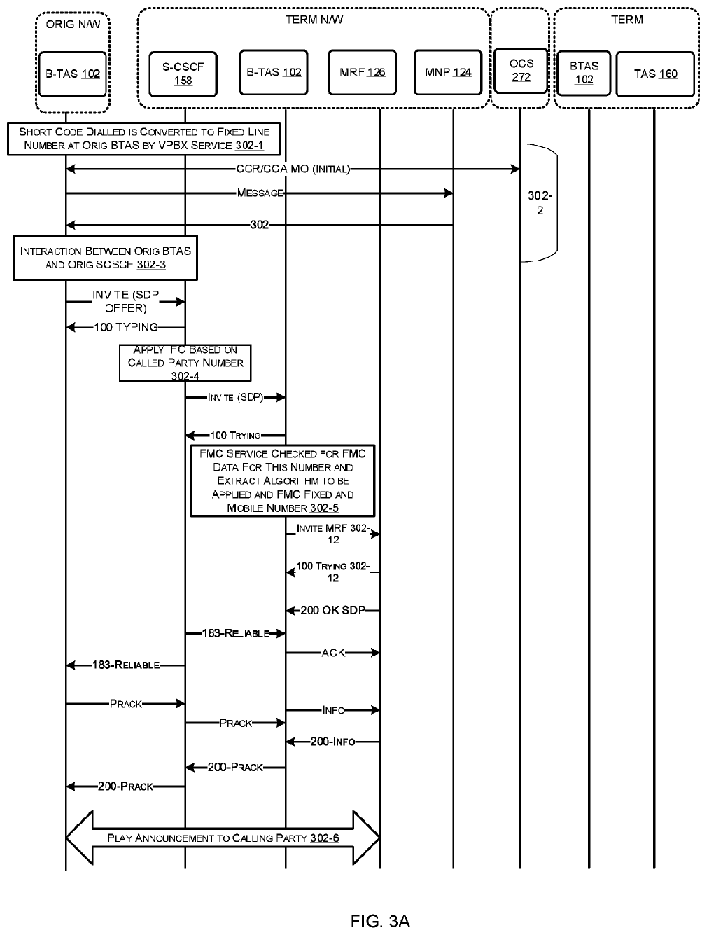

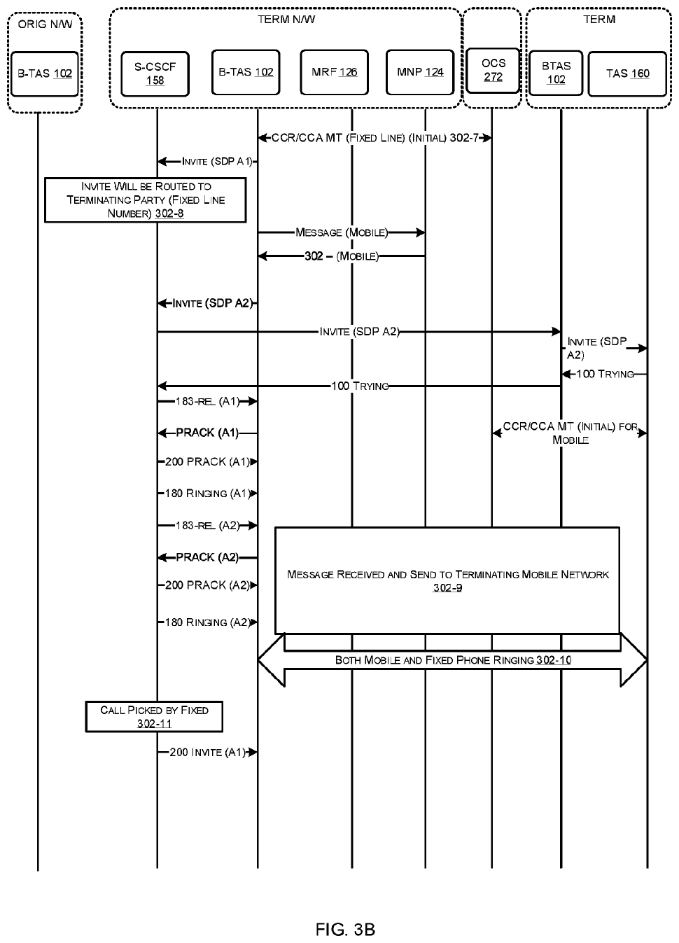

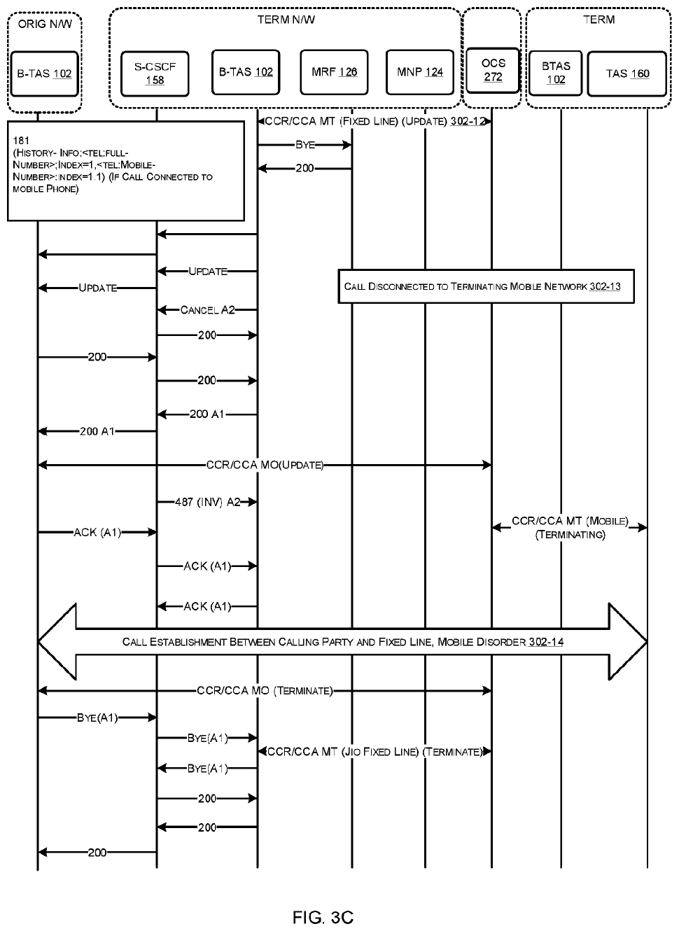

FIGS. 3A-3C illustrate exemplary sequence diagram representations of parallel call forking flows, in accordance with an embodiment of the present disclosure.

As shown in FIGS. 3A-3C, an originating network may include the B-TAS (102), and the terminating network may include the SCSCF (158), the BTAS (102), the MRF (126), the MNP (124), and the TAS (160). Further, the OCS (272) may be included for charging a call.

At step (302-1), dialed short code is converted to a fixed-line number by BTAS (102) using a Virtual PBX (VPBX) service. At step (302-2), the BTAS (102) may trigger charging to OCS (272) using a Credit-Control-Request (CCR), and the OCS (272) may transmit back a Credit-Control-Answer (CCA) to the BTAS (102). At step (302-3), the BTAS (102) may interact with SCSCF at the origin network.

At step (302-4), the SCSCF (158) may apply Initial Filter Criteria (IFC) based on called party number. At step (302-5), BTAS (102) may check FMC Service for FMC Data for this number and extract algorithm to be applied and FMC fixed and mobile number.

At step (302-6), the announcement is played to the calling party. At step (302-7), the BTAS (102) may trigger charging to OCS (272). At step (302-8), the invite may be routed to the terminating party (fixed-line number). At step (302-9), INVITE messages are sent to the terminating mobile network.

At step (302-10), ringing both the mobile device (110) and the fixed line device (110). At step (302-11), the call is answered by the called party, for example, fixed-line. At step (302-12), trigger update charging as the fixed line to the OCS (272). At step (302-13), disconnect the call to the terminating mobile network, when the call is answered on a fixed line. At step (302-14), establish a call between the calling party and the fixed line, and disconnect the mobile. The other steps in the sequence diagram may be a general call flow known to the person skilled in the relevant art.

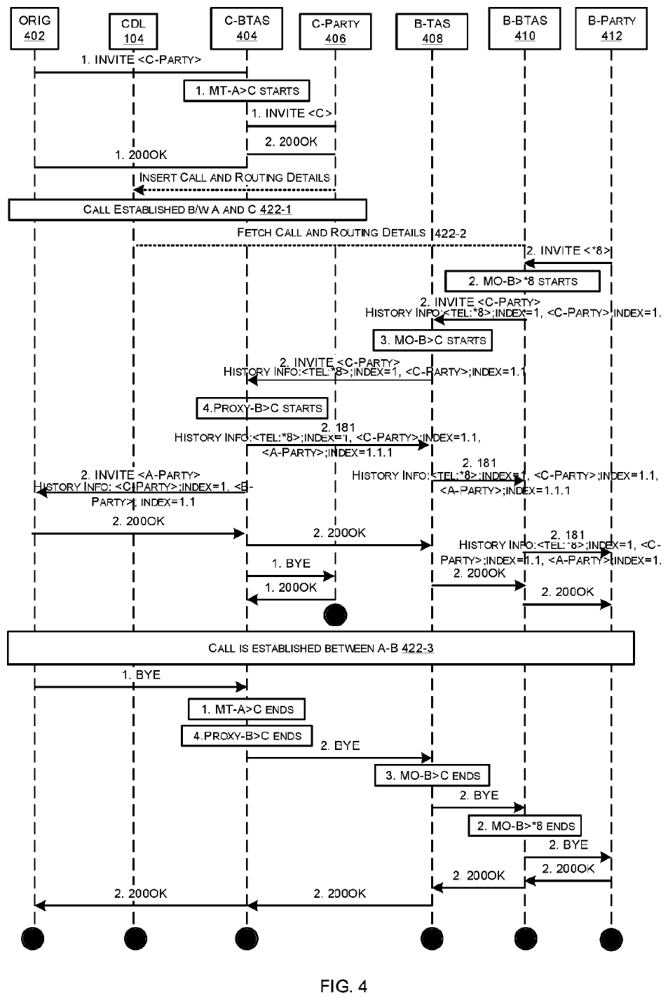

FIG. 4 illustrates an exemplary sequence diagram representation of a call flow for seamless call pickup, in accordance with an embodiment of the present disclosure.

Consider a scenario, where a call may be answered from a mobile number (C-party) (406) associated with its fixed-line (B-party) (412). At step (422-1) call may be established between A party (ORIG (402)) and C party (406), upon inserting call and routing details by the C-party (406) to the CDL server (104). At step (422-2), the B-BTAS (410) of the B party (412) fetches the call and routing details from the CDL server (104). At step (422-3), the call is established between the A party (402) and the B party (412). The other steps in the sequence diagram may be a general call flow known to the person skilled in the relevant art.

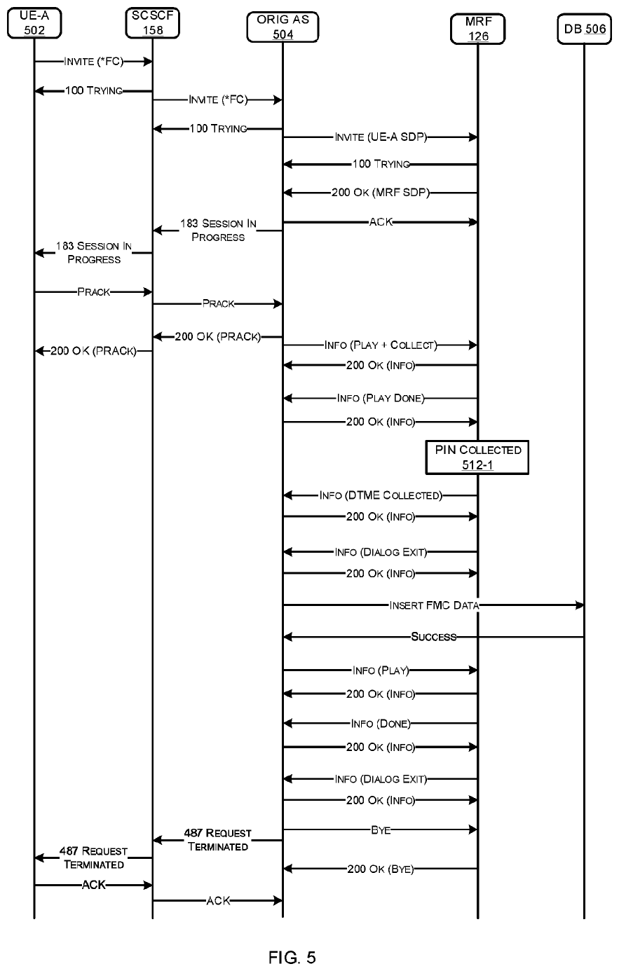

FIG. 5 illustrates an exemplary sequence diagram representation of call Flow (activation/deactivation) of the FMC service, in accordance with an embodiment of the present disclosure.

Activation from the Centrex user in which the FMC is provisioned, dial for example, “*333”. At step (512-1), the MRF (126) may prompt the user to input a 4-digit pin via Dual-Tone Multi-Frequency (DTMF) tones. Only after correct pin input, the service may be activated. Deactivation from the Centrex user in which the FMC is provisioned, dial “#333”. This may prompt the user to give a 4-digit pin via the DTMF tones. Only after correct pin input at step (512-1), the service may be deactivated. The FMC service may not be deleted, however, deactivated until activated by the user. Only activation/deactivation may be allowed using facility codes. Provisioning of the FMC service may be performed via the EPS (260) only. The other steps in the sequence diagram may be a general call flow known to the person skilled in the relevant art.

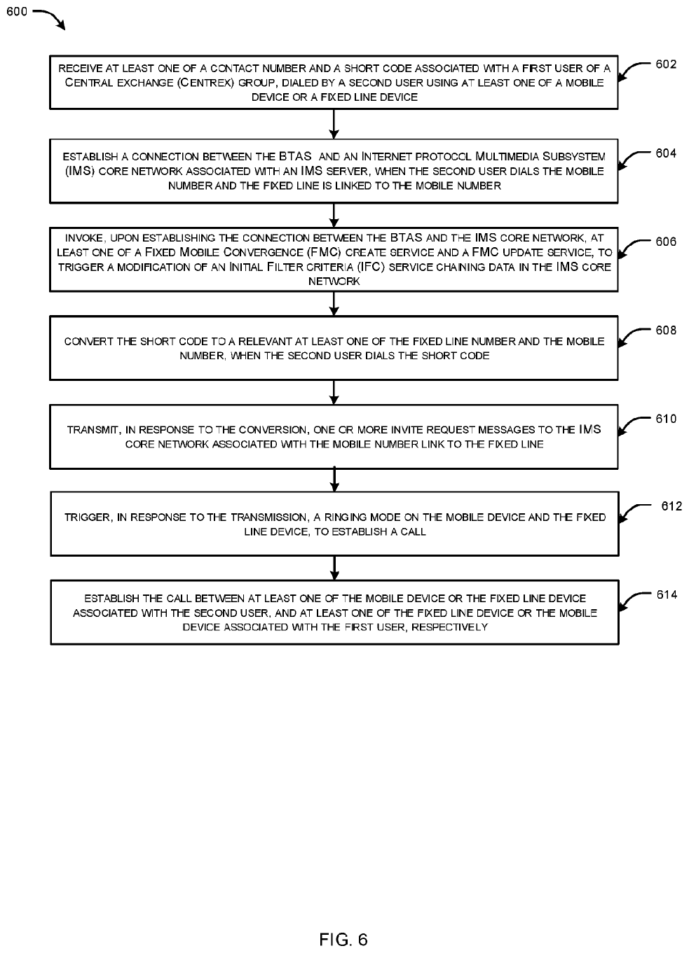

FIG. 6 illustrates an exemplary flow chart for a method (600) of providing a Fixed Mobile Convergence (FMC) service, in accordance with an embodiment of the present disclosure.

At block (602), the method (600) may include receiving, by the processor (202) associated with a Business Telephony Application Server (BTAS) (102), based on executing the SM (212), at least one of a contact number and a short code associated with a first user of a Central exchange (Centrex) group, dialed by a second user using at least one of a mobile device or a fixed line device (i.e., the user device (110)). The contact number and the short code may correspond to at least one of a mobile number and a fixed line number associated with the first user of the Centrex group.

At block (604), the method (600) may include establishing, by the processor (202) on executing the SM (212), a connection between the BTAS (102) and an Internet protocol Multimedia Subsystem (IMS) core network (106) associated with the IMS server (106), when the second user dials the mobile number and the fixed line is linked to the mobile number.

At block (606) the method (600) may include invoking, by the processor (202) on executing the SM (212), upon establishing the connection between the BTAS (102) and the IMS core network (106), at least one of a Fixed Mobile Convergence (FMC) create service and a FMC update service, to trigger a modification of an Initial Filter criteria (IFC) service chaining data in the IMS core network (106).

At block (608) the method (600) may include converting, by the processor (202) on executing the SM (212), the short code to a relevant at least one of the fixed line number and the mobile number, when the second user dials the short code. The function performed at step 608 may be similar to functions performed at steps 302-1, 302-3, 302-5, and 302-6 of FIG. 3A.

At block (610) the method (600) may include transmitting, by the processor (202) on executing the SM (212), in response to the conversion, one or more invite request messages to the IMS core network (106) associated with the mobile number link to the fixed line. The function performed at step 610 may be similar to functions performed at steps 302-8, 302-9, 302-10, and 302-11 of FIG. 3B.

At block (612) the method (600) may include triggering, by the processor (202) on executing the SM (212), in response to the transmission, a ringing mode on the mobile device (110), and the fixed line device (110), to establish a call.

At block (614) the method (600) may include establishing, by the processor (202) on executing the SM (212), the call between at least one of the mobile device (110) or the fixed line device (110) associated with the second user, and at least one of the fixed line device (110) or the mobile device (110) associated with the first user, respectively.

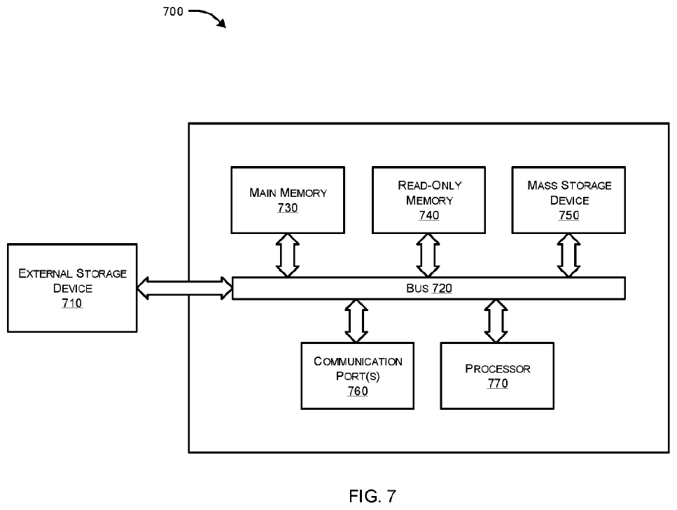

FIG. 7 illustrates an exemplary computer system (700) in which or with which embodiments of the present invention can be utilized, in accordance with embodiments of the present disclosure.

As shown in FIG. 7, the computer system (700) can include an external storage device (710), a bus (720), a main memory (730), a read-only memory (740), a mass storage device (750), communication port (760), and a processor (770). A person skilled in the art will appreciate that the computer system may include more than one processor and communication ports. Processor (770) may include various modules associated with embodiments of the present invention. Communication port (760) can be any of an RS-232 port for use with a modem-based dialup connection, a 10/100 Ethernet port, a Gigabit, or 10 Gigabit port using copper or fiber, a serial port, a parallel port, or other existing or future ports. Communication port (760) may be chosen depending on a network, such as a Local Area Network (LAN), Wide Area Network (WAN), or any network to which the computer system connects. Memory (730) can be Random Access Memory (RAM), or any other dynamic storage device commonly known in the art. Read-only memory (740) can be any static storage device(s) e.g., but not limited to, a Programmable Read-Only Memory (PROM) chips for storing static information e.g., start-up or BIOS instructions for the processor (770). Mass storage (750) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks (e.g., SATA arrays).

Bus (720) communicatively coupled processor(s) (770) with the other memory, storage, and communication blocks. Bus (720) can be, e.g., a Peripheral Component Interconnect (PCI)/PCI Extended (PCI-X) bus, Small Computer System Interface (SCSI), USB, or the like, for connecting expansion cards, drives, and other subsystems as well as other buses, such a front side bus (FSB), which connects processor (770) to a software system.

Optionally, operator and administrative interfaces, e.g., a display, keyboard, and a cursor control device, may also be coupled to the bus (720) to support direct operator interaction with a computer system. Other operator and administrative interfaces can be provided through network connections connected through a communication port (760). The components described above are meant only to exemplify various possibilities. In no way should the aforementioned exemplary computer system limit the scope of the present disclosure.

While considerable emphasis has been placed herein on the preferred embodiments, it will be appreciated that many embodiments can be made and that many changes can be made in the preferred embodiments without departing from the principles of the invention. These and other changes in the preferred embodiments of the invention will be apparent to those skilled in the art from the disclosure herein, whereby it is to be distinctly understood that the foregoing descriptive matter is to be implemented merely as illustrative of the invention and not as a limitation.

### ADVANTAGES OF THE PRESENT DISCLOSURE

The present disclosure provides systems and methods for providing a Fixed Mobile Convergence (FMC) service using a Business Telephony Application Server (BTAS) associated with a Central exchange (Centrex) group.

The present disclosure provides systems and methods to convert a short code to a relevant fixed line number and ring both mobile and fixed line.

The present disclosure determines, if the call is answered on a fixed line or mobile device, and then disconnects the call on a mobile/fixed line, when the call is answered on fixed line/mobile, respectively.

The present disclosure allows short code dialing from mobile in addition to fixed line phone of an enterprise user, in the cloud Internet Protocol (IP) Central exchange (Centrex).

The present disclosure provides a single extension/number for a user to receive incoming calls on both devices (i.e., mobile as well as a fixed-line phone).

The present disclosure enables user experience including dialing from a mobile phone, dialing from the fixed phone, calling from outside Enterprise user to fixed phone, and seamless call pickup from associated fixed or mobile.

The present disclosure allows seamless call pickup, where the call is answered up from a mobile number (e.g., C-party) associated with the respective fixed line (e.g., B-party).

### RESERVATION OF RIGHTS

A portion of the disclosure of this patent document contains material which is subject to intellectual property rights such as, but are not limited to, copyright, design, trademark, IC layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

We claim:

1. A system (100) for providing a Fixed Mobile Convergence (FMC) service, the system (100) comprising:
a Business Telephony Application Server (BTAS) (102), the BTAS (102) comprising:
a processor (202); and
a memory (204) coupled to the processor (202), wherein the memory (204) comprises processor-executable instructions, which on execution, cause the processor (202) to:
receive at least one of a contact number and a short code associated with a first user of a Central exchange (Centrex) group, dialed by a second user using at least one of a mobile device (110) or a fixed line device (110), wherein the contact number and the short code corresponds to at least one of a mobile number and a fixed line number associated with the first user of the Centrex group;
establish a connection between the BTAS (102) and an Internet protocol Multimedia Subsystem (100) (IMS) core network (106) associated with an IMS server (106), when the second user dials the mobile number and the fixed line is linked to the mobile number;
invoke, upon establishing the connection between the BTAS (102) and the IMS core network (106), at least one of a Fixed Mobile Convergence (FMC) create service and a FMC update service, to trigger a modification of an Initial Filter criteria (IFC) service chaining data in the IMS core network (106);
convert the short code to a relevant at least one of the fixed line number and the mobile number, when the second user dials the short code;
in response to the conversion, transmit one or more invite request messages to the IMS core network (106) associated with the mobile number link to the fixed line;
in response to the transmission, trigger a ringing mode on the mobile device (110) and the fixed line device (110), to establish a call; and
establish the call between at least one of the mobile device (110) or the fixed line device (110) associated with the second user, and at least one of the fixed line device (110) or the mobile device (110) associated with the first user, respectively.

2. The system (100) as claimed in claim 1, wherein the processor (202) is further configured to:
determine periodically if, the call is answered on the fixed line device (110) or the mobile device (110), by the first user; and
disconnect the call in the mobile device (110) or the fixed line device (110) associated with the first user, when the call is answered in fixed line device (110) or the mobile device (110), respectively, wherein the call is established upon disconnecting the call in the mobile device (110) or the fixed line device (110), respectively.

3. The system (100) as claimed in claim 1, wherein, when the short code corresponds to the fixed line number, the processor (202) is further configured to:
convert the dialed short code to the fixed line number using a Virtual Private Branch Exchange (VPBX) service;
trigger an Online Charging System (OCS) (272), for charging the second user, using a Credit Control Request (CCR), wherein the OCS (272) transmits back a Credit Control Answer (CCA) corresponding to the CCR;
interact with a Serving Call Session Control Function (SCSCF) associated with the IMS core network (106), wherein the SCSCF applies the Initial Filter Criteria (IFC) based on at least one of the mobile number and the fixed line number of the first user;
determine an appropriate Fixed Mobile Convergence (FMC) service to be invoked for FMC data associated with the at least one of the mobile number and the fixed line number of the first user;
provide at least one of an announcement and a ring tone to the second user;
route invite to the fixed line number associated with the first user, and invite request messages to the IMS core network (106) associated with the mobile number;
trigger a ringing mode on the mobile device (110) and the fixed line device (110), to establish the call; and
trigger the OCS (272) for update charging as the at least one of the fixed line number and the mobile number, based on answering of the call by the first user in fixed line device (110) or the mobile device (110), respectively, wherein the call is established between the fixed line device (110) associated with the second user, and at least one of the fixed line device (110) or the mobile device (110) associated with the first user, respectively, based on answering of the call;

4. The system (100) as claimed in claim 1, wherein answering the call further comprises an event of answering the call from the mobile number associated with a third user when the call is established in the fixed-line number associated with the second user, wherein the processor (202) is further configured to:
establish the call between the first user and the third user, upon inserting call details and routing details by the third user to a Centralized Data Layer (CDL) server (104);
fetch, by the BTAS (102) associated with the second user, the call details and routing details from the CDL server (104); and
establish the call between the first user and the second user.

5. The system (100) as claimed in claim 1, wherein triggering the ringing mode on the mobile device (110) and the fixed line device (110) further comprises at least one of a ringing simultaneously on the fixed line device (110) and the mobile device (110), and ringing sequentially first on the fixed line device (110) and then on the mobile device (110), based on a provisioned parallel forking mode or a sequential forking mode.

6. The system (100) as claimed in claim 1, wherein the fixed line device (110) associated with the first user displays a Calling Line Identification (CLI), and the mobile device (110) associated with the first user displays the mobile number of the second user.

7. The system (100) as claimed in claim 1, wherein the fixed line device (110) associated with the second user displays a Calling Line Identification (CLI) and the mobile device (110) associated with the second user displays the short code of the first user.

8. The system (100) as claimed in claim 1, wherein when the ringing mode is triggered on at least one of the fixed line devices (110) and the mobile device (110), the first user answers the call alternatively on an alternate contact number, by dialing a service code from the alternate contact number.

9. The system (100) as claimed in claim 1, wherein the FMC service is activated upon inputting a pin via Dual-Tone Multi-Frequency Tones (DTMF), and the FMC service is deactivated upon inputting a pin via the DTMF, and wherein the FMC service is not deleted during deactivation.

10. A method for providing a Fixed Mobile Convergence (FMC) service, the method comprising:
receiving, by a processor (202) associated with a Business Telephony Application Server (BTAS) (102) in a system (100), at least one of a contact number and a short code associated with a first user of a Central exchange (Centrex) group, dialed by a second user using at least one of a mobile device (110) or a fixed line device (110), wherein the contact number and the short code corresponds to at least one of a mobile number and a fixed line number associated with the first user of the Centrex group;
establishing, by the processor (202), a connection between the BTAS (102) and an Internet protocol Multimedia Subsystem (100) (IMS) core network (106) associated with an IMS server (106), when the second user dials the mobile number and the fixed line is linked to the mobile number;
invoking, by the processor (202), upon establishing the connection between the BTAS (102) and the IMS core network (106), at least one of a Fixed Mobile Convergence (FMC) create service and a FMC update service, to trigger a modification of an Initial Filter criteria (IFC) service chaining data in the IMS core network (106);
converting, by the processor (202), the short code to a relevant at least one of the fixed line number and the mobile number, when the second user dials the short code;
in response to the conversion, transmitting, by the processor (202), one or more invite request messages to the IMS core network (106) associated with the mobile number link to the fixed line;
in response to the transmission, triggering, by the processor (202), a ringing mode on the mobile device (110) and the fixed line device (110), to establish a call; and
establishing, by the processor (202), the call between at least one of the mobile device (110) or the fixed line device (110) associated with the second user, and at least one of the fixed line device (110) or the mobile device (110) associated with the first user, respectively.

11. The method as claimed in claim 10, further comprising:
determining periodically, by the processor (202), if, the call is answered on the fixed line device (110) or the mobile device (110), by the first user; and
disconnecting, by the processor (202), the call in the mobile device (110) or the fixed line device (110) associated with the first user, when the call is answered in fixed line device (110) or the mobile device (110), respectively, wherein the call is established upon disconnecting the call in the mobile device (110) or the fixed line device (110), respectively.

12. The method as claimed in claim 10, wherein, when the short code corresponds to the fixed line number, the method further comprises:
converting, by the processor (202), the dialed short code to the fixed line number using a Virtual Private Branch Exchange (VPBX) service;
triggering, by the processor (202), an Online Charging System (OCS) (272), for charging the second user, using a Credit Control Request (CCR), wherein the OCS (272) transmits back a Credit Control Answer (CCA) corresponding to the CCR;
interacting, by the processor (202), with a Serving Call Session Control Function (SCSCF) associated with the IMS core network (106), wherein the SCSCF applies the Initial Filter Criteria (IFC) based on at least one of the mobile number and the fixed line number of the first user;
determining, by the processor (202), an appropriate Fixed Mobile Convergence (FMC) service to be invoked for FMC data associated with the at least one of the mobile number and the fixed line number of the first user;
providing, by the processor (202), at least one of an announcement and a ring tone to the second user;
routing, by the processor (202), invite to the fixed line number associated with the first user, and invite request messages to the IMS core network (106) associated with the mobile number;
triggering, by the processor (202), a ringing mode on the mobile device (110) and the fixed line device (110), to establish the call; and
triggering, by the processor (202), the OCS (272) for update charging as the at least one of the fixed line number and the mobile number, based on answering of the call by the first user in fixed line device (110) or the mobile device (110), respectively, wherein the call is established between the fixed line device (110) associated with the second user, and at least one of the fixed line device (110) or the mobile device (110) associated with the first user, respectively, based on answering of the call.

13. The method as claimed in claim 10, wherein answering the call further comprises an event of answering the call from the mobile number associated with a third user when the call is established in the fixed-line number associated with the second user, wherein the method further comprises:
establishing, by the processor (202), the call between the first user and the third user, upon inserting call details and routing details by the third user to a Centralized Data Layer (CDL) server (104);
fetching, by the processor (202), via the BTAS (102) associated with the second user, the call details and routing details from the CDL server (104); and
establishing, by the processor (202), the call between the first user and the second user.

14. The method as claimed in claim 10, wherein triggering the ringing mode on the mobile device (110) and the fixed line device (110) further comprises at least one of a ringing simultaneously on the fixed line device (110) and the mobile device (110), and ringing sequentially first on the fixed line device (110) and then on the mobile device (110), based on a provisioned parallel forking mode or a sequential forking mode.

15. The method as claimed in claim 10, wherein the fixed line device (110) associated with the first user displays a Calling Line Identification (CLI), and the mobile device (110) associated with the first user displays the mobile number of the second user.

16. The method as claimed in claim 10, wherein the fixed line device (110) associated with the second user displays a Calling Line Identification (CLI) and the mobile device (110) associated with the second user displays the short code of the first user.

17. The method as claimed in claim 10, wherein when the ringing mode is triggered on at least one of the fixed line device (110) or the mobile device (110), the first user answers the call alternatively on an alternate contact number, by dialing a service code from the alternate contact number.

18. The method as claimed in claim 10, wherein the FMC service is activated upon inputting a pin via Dual-Tone Multi-Frequency Tones (DTMF), and the FMC service is deactivated upon inputting a pin via the DTMF, and wherein the FMC service is not deleted during deactivation.

19. A User Equipment (UE) for providing a Fixed Mobile Convergence (FMC) service, the UE comprising:
a processor; and
a memory coupled to the processor, wherein the memory comprises processor-executable instructions, which on execution, cause the processor to:
transmit at least one of a contact number and a short code associated with a first user of a Central exchange (Centrex) group, dialed by a second user using at least one of the user equipment, wherein the contact number and the short code correspond to at least one of a mobile number and a fixed line number associated with the first user; and
establish a call between the user equipment associated with the second user and the first user.

20. A non-transitory computer readable medium comprising machine-readable instructions that are executable by a processor to:
receive at least one of a contact number and a short code associated with a first user of a Central exchange (Centrex) group, dialed by a second user using at least one of a mobile device (110) or a fixed line device (110), wherein the contact number and the short code corresponds to at least one of a mobile number and a fixed line number associated with the first user of the Centrex group;
establish a connection between a Business Telephony Application Server (BTAS) (102) and an Internet protocol Multimedia Subsystem (100) (IMS) core network (106) associated with an IMS server (106), when the second user dials the mobile number and the fixed line is linked to the mobile number;
invoke, upon establishing the connection between the BTAS (102) and the IMS core network (106), at least one of a Fixed Mobile Convergence (FMC) create service and a FMC update service, to trigger a modification of an Initial Filter criteria (IFC) service chaining data in the IMS core network (106);
convert the short code to a relevant at least one of the fixed line number and the mobile number, when the second user dials the short code;
in response to the conversion, transmit one or more invite request messages to the IMS core network (106) associated with the mobile number link to the fixed line;
in response to the transmission, trigger a ringing mode on the mobile device (110) and the fixed line device (110), to establish a call; and
establish the call between at least one of the mobile device (110) or the fixed line device (110) associated with the second user, and at least one of the fixed line device (110) or the mobile device (110) associated with the first user, respectively.
